(19) United States
(12) Patent Application Publication
(10) Pub. No.: US 2023/0359947 A1
(43) Pub. Date: Nov. 9, 2023

(54) System and method for increasing probability of making a ride in a p2p ride-hailing service

(71) Applicant: Suol Innovations Ltd., Nicosia (CY)

(72) Inventors: Maxim Grigoriev, Yakutsk (RU); Sergei Dereviashkin, Yakutsk (RU); Aleksandr Akimenko, Yakutsk (RU)

(21) Appl. No.: 17/738,190

(22) Filed: May 6, 2022

(51) Int. Cl. G06Q 10/02; G06Q 20/22; G06Q 30/02

(52) U.S. Cl. CPC G06Q 10/025; G06Q 20/223; G06Q 30/0281; G06Q 50/30

(57) ABSTRACT

System for optimizing matching drivers and passengers in p2p ride service, includes a server receiving orders from passengers; filtering orders for validity; placing orders into buffer and determining optimal time to remain there; generating set of active drivers; generating possible matched pairs of passengers and drivers, where every possible passenger with order is paired to every possible active driver; filtering them to determine pairs that satisfy both passenger's and driver's criteria; for each filtered matched pair, calculating probability of ride taking place and ranking filtered matched pairs; selecting optimal matched pairs for each passenger and each driver, where each driver only has one passenger, but passenger can have multiple possible drivers; for orders that are pushed out of buffer after pre-defined time, sending notifications to drivers from selected optimal matched pairs; for accepted orders with counteroffers, passengers are notified, passenger can accept or decline driver/counteroffer.

### BACKGROUND OF THE INVENTION

### Field of the Invention

The invention relates to peer-to-peer (p2p) ride-hailing services, and, more particularly, to optimizing the matching process between potential drivers and potential passengers.

### Description of the Related Art

In ride-hailing systems, a problem exists of optimally matching drivers with riders. The objective of a ride-hailing service is not only to enable trips, but also to optimize various parameters for all participants, i.e., drivers, riders, and the ride-hailing system as a whole. Such parameters may include, but are not limited to (1) Probability that the rider may leave within the expected period of time (2) Driver's downtime between rides, (3) Matching price expectations of the driver and rider, and/or (4) Total number of completed rides.

The problem is even more urgent in case the ride-hailing system is a p2p service, not just an ordinary taxi-hailing system, where there are no “sanctions” for changing one's mind. Unlike taxi services, the driver in a p2p service does not have to accept the first ride request in the queue prepared by the system. Similarly, the rider does not have to ride with the first and only driver, or the first driver offered to him or her by the system. The problem is particularly acute in a p2p system where the price can be negotiated by the passenger.

Most conventional solutions are based on comparing and ranking driver-rider matches, where the top-ranked match is processed further, i.e., the driver is invited to accept a request with a specified route and price, and the rider (in case the driver accepts) is assigned a specified driver.

A “naïve” solution is matching the driver and the rider that are closest to each other geographically. If the closest driver rejects the ride request, then the second closest (or the one that can be available sooner) is chosen, etc. However, such a “naïve” solution is not optimal considering the framework of whole ride-hailing network, especially in p2p systems, where the probability of rejected notifications is higher.

### SUMMARY OF THE INVENTION

In one aspect of the present invention, a system for optimizing matching drivers and passengers in a p2p ride service, includes a mobile phone with an application that connects to a server, that passengers can use to place an order for a ride; the application including an option to function as a driver application that a driver can use to accept the order placed by the passenger; the server receiving the orders from multiple passengers; the server filtering the orders to ensure that the order is valid given a set of pre-defined parameters; the server placing the orders into a buffer and determining an optimal time for each order to remain in the buffer, based on historical data for the passenger and current traffic and driver availability data; the server generating a set of active drivers; the server generating a set of possible matched pairs of passengers and drivers, where every possible passenger with an outstanding order is paired to every possible active driver; the server filtering the possible matched pairs to determine those matched pairs that satisfy both the passenger's criteria and the driver's criteria; for each filtered matched pair, the server calculating a probability of the ride taking place; the server ranking the filtered matched pairs based on the probability; the server selecting optimal matched pairs, out of the filtered matched pairs, for each passenger and each driver, such that each driver only has one possible passenger, but each passenger can have multiple possible drivers; after the orders being kept in buffer for a long enough time, the server sending notifications to the corresponding drivers from the selected optimal matched pairs; for those orders that are accepted by the drivers with their counteroffers, the corresponding passengers are notified by the server, and the passenger is given an option to either accept this driver and his counteroffer or decline this driver.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 shows a system block diagram of an exemplary implementation of the invention.

FIG. 2 shows a flowchart of the algorithm for performing the invention.

FIG. 3 shows a passenger's smartphone screen for creating an order, with an offering price (here, in rubles).

FIG. 4 shows a driver's screen, notifying him of the incoming order.

FIG. 5 shows a passenger's screen, as he waits for the driver to either accept the order or to counter with a higher price.

FIG. 6 shows a driver's screen, with the active/inactive option at the top.

FIG. 7 shows an exemplary computer system or server for implementing the invention.

FIG. 8 is a block diagram of an exemplary mobile device that can be used in the invention.

FIG. 9 is a block diagram of an exemplary implementation of the mobile device.

### DETAILED DESCRIPTION OF EMBODIMENTS OF THE INVENTION

Reference will now be made in detail to the preferred embodiments of the present invention, examples of which are illustrated in the accompanying drawings.

### Variant 1

The majority of conventional ride-hailing systems do not allow riders to choose drivers and vice versa, since giving both the rider and the driver an option to reject the ride makes the matching process significantly more complicated. It becomes necessary to take into account individual characteristics and preferences of drivers and/or riders.

Example 1: Driver A prefers longer trips, and Driver B prefers shorter trips inside a specified district. If Driver B keeps receiving requests for longer trips, they will reject them, which results in that the request has to be forwarded to another driver. Thus, the rider has to wait longer for a car, and the original driver is left without appropriate ride requests. As a result, the wait times for passengers increase, and both the quality of the service and the company's revenue suffer.

Example 2: Some passengers prefer to arrive at their destination faster, and are willing to pay extra for it, others can wait, but prefer to pay less. Some passengers might prefer a more comfortable car, because the distance they are going to is greater.

### Proposed Solution

The “feature vector” concept is used—an ordered set of numbers reflecting certain characteristics of an object. These numbers may reflect real physical characteristics of an object (e.g., its average speed) or its encoded characteristics (e.g., a car model can be encoded as a serial number of the model in an alphabetical list containing all existing car models).

Pre-generated feature vectors for riders and drivers can be used. A rider's feature vector may include the following: the rider's rating, average waiting time before cancelling the ride, recent activity, accepted rides ratio, average price per km or mile. Similarly, a driver's feature vector may include the following: the driver's current location, their experience and rating, car they're driving, recent activity, typical schedule, successfully completed rides, preferred destinations, price per km, decision-making speed, and, possibly, driver's activity/inactivity.

In case there are no historical data on the rider or driver (too few rides made with the service), it is assumed that their preferences are similar to those of an average user of the service. Alternatively, user preferences can also be encoded by feature vectors. Feature vectors are re-calculated upon receiving updated information on drivers and riders.

When a ride request is created, the request from the rider's device is processed by the system and a feature vector is generated for the ride request, including the following information: pick-up point, drop-off point, price, time of day. In case the ride parameters are changed (e.g., the rider raises the price), its feature vector is updated. Next, the data about the request gets into a ride request buffer in real time. A ride request buffer is a data structure for temporary storing queues of riders' requests. Ride notifications are not sent to drivers immediately. Each request is buffered for a certain period of time that is determined by the system. The buffer contains information about all requests that are currently waiting for a driver to react. As soon as the ride is started or cancelled, the request is removed from the buffer.

For each buffered request, the system determines active drivers that are located at a reasonable distance from the potential rider. A driver is considered to be ‘active’, if their status in the app is “On-line”. The driver can change their status manually. Next, a set of driver-request pairs is generated considering the ride parameters provided by the rider, such as child safety seat availability, increased passenger capacity, etc.

For all possible matches, the probability of a successful ride is calculated using a statistical model. A feature vector is generated for the ride request, including the following information: pick-up point, drop-off point, price, time of day. In case the ride parameters are changed (e.g., the rider raises the price), its feature vector is updated. Feature vectors for the rider, driver, and ride request are used as inputs for a statistical model that predicts the probability of a successful negotiation between the driver and the rider, and the ride will be made. The statistical model is based on historical data, which are available to the provider of the service. This statistical model may be represented by machine learning models, such as supervised learning (regression, linear models, random forest, gradient boosting, deep learning) or reinforcement learning. As new data on accepted/rejected offers become available, the model is trained again and updated.

By analyzing the information about all possible driver-request matches (including the probability that the notification will result in a ride), it is possible to select matches for sending notifications.

The matching process can be optimized by, for example (1) Total number of completed rides, (2) Probability that the rider may leave within the expected period of time, (3) Driver's downtime between rides, and/or (4) Driver's profit.

Here, the total number of completed rides grows when the algorithm calculates the probability of the ride and selects pairs with the highest probabilities. Thus, the total probability of the ride occurring for the entire system is maximized. As a consequence, the total number of rides is maximized.

Probability that the rider may leave within the expected period of time increases because the rider preferences are taken into account when calculating the probabilities (e.g., price, how fast the car will get there, the type of car, etc.).

Driver's downtime between rides is expected to decrease. The algorithm can select pairs with the highest probability of the ride occurring, and, therefore, the drivers will get notifications faster about potential passengers who are most likely to become actual passengers.

Driver's profit should increase since the idle time between rides should decrease.

The matching system could be fine-tuned for usage at different conditions (i.e. different cities) by adjusting the system parameters, such as minimum time a request is buffered; maximum notifications for each request; maximum distance between the driver's location and the ride pick-up point, beyond which notifications cannot be sent; etc.

For the driver activity/inactivity parameter, unlike conventional approach, the proposed system permits selection of a driver from a set that includes not merely all the drivers in some radius, but only those who actually respond to the bid-counteroffer auction. This permits the entire system to reduce the load on it, by reducing the wait time for the vehicle, reducing the time the driver spends idling, and reducing the overall time utilized by the physical resource (the vehicle) as it relates to the particular passenger and driver. Ultimately, this affects efficiency of both the vehicle use and the server (i.e., less memory, less database use, fewer database read/writes/accesses, and so on—this is not a problem when the “universe” includes only a handful of passengers and drivers, but for a large-scale system, such as a city-wide service or a state-wide service, it implicates significant savings). Since the algorithm permits sending fewer notifications to the drivers, this means (i) the server load on the servers that are actually involved in sending notifications to the drivers' apps is reduced, and (ii) that requests to external APIs related to these notifications are also reduced (for example, requests to Google mapping API, requests to a route-calculation API, and so on).

The drivers that actually are interested in this passenger are known earlier in the process, due to their participation in the bid-counteroffer negotiation. For example, active drivers (i.e., ones who respond to the bid-counteroffer negotiations) will see the passenger and be given the opportunity to make counter-offers, while inactive drivers will be ignored. For those inactive drivers, the server does not need to perform any other activities, like calculations of times, routes, etc., reducing the load on the server. The server knows which driver activated the application on his application, which drivers have a list of passengers/potential rides displayed, which ones are actually bidding on the rides, activity per unit time—this permits the server to optimize its efforts towards those active drivers, rather than towards all the drivers who happen to be in some radius. Similarly, the server knows which drivers have a high rate of “interest” but a relatively low rate of actual successful negotiations with the passengers, again, permitting to optimize system resources by de-prioritizing such drivers. Thus, the system permits a significant improvement in resource utilization—both at overall vehicle/network level and at the server level.

The parameters of the system can be both static and dynamic. Dynamic parameters change depending on the time of day, ride characteristics, and the overall situation (the number of free drivers, the number of active ride requests, etc.) using a pre-defined algorithm. (The static parameters were described above, such as minimum time a request is buffered, maximum notifications for each request; maximum distance between the driver's location and the ride pick-up point, beyond which notifications cannot be sent.)

Example 1—adjusting the number of notifications per request. The driver, having received a notification, is busy responding to that notification and becomes unavailable for a short time. There are not enough drivers in rush hours. Sending out a large number of ride notifications in this situation may further aggravate the shortage of drivers, wherein some ride requests will remain unfulfilled. It would be better to send out fewer notifications.

Example 2. In case the ride request offers a higher-than-average price per km, it is likely that many drivers would respond to it. Therefore, it is unnecessary to send out many notifications.

Example 3. Some riders like to be able to choose, so they wait until at least two drivers respond to their ride request before making a choice. It would be better to send out more notifications for such riders.

As a result, the matching system provides a set of driver-rider matches, which are used by the server to send notifications to the drivers.

The system can rank matches according to the probability of making a ride. As soon as the ride is started, the system finishes its work.

On the driver side, the bid-counteroffer negotiation permits the driver to optimize his own behavior by selecting passengers where it makes economic sense, thus reducing his expenses (e.g., fuel costs, tolls, and so on). Physically, this means that the use of resources (vehicles) is also optimized, in addition to server optimization.

### Variant 2

A further development of the earlier-described scenario of variant 1, the system allows the driver to consider multiple ride requests, which allows them to have a wider range of relevant ride requests to choose from.

Ride requests from riders are queued, i.e., buffered. Ride requests from riders' client apps are processed by the system and are buffered in real time. Ride requests are supplemented by historical data available to the provider of the service. A buffer itself is a system comprising an information processing server and a queue server, for temporarily storing a queue of ride requests. The time of storing (buffering time) can be determined either manually or automatically based on the rider's history of ride requests. In the proposed system, notifications cannot be sent to the driver immediately after a ride request appears in the buffer. There is a short delay between the ride request entering the buffer and the first notification sent. The delay is called the buffering time. Such a delay is barely noticeable by the users. The buffer contains information about all pending ride requests, for which the driver has not been chosen yet. Ride requests are updated dynamically upon receiving new data. As soon as the ride is started or cancelled, the request is removed from the buffer.

Active drivers are also buffered. Drivers' information is updated dynamically upon receiving new data (i.e., the driver's app location is changed, the driver's status is changed, etc.).

Buffering time is a dynamic value that is determined based on the current supply-to-demand ratio, the average time before a rider cancels their ride request, the average time before a rider raises the ride price. Buffering time can be calculated, for example (1) based on an empirical formula; (2) based on a formula that is calculated using historical data and using a machine learning model, such as supervised learning; or (3) based on a formula that is calculated using historical data and using a deep-learning model, such as reinforcement learning, etc.

The buffer can be based not only on time, but also on the number of participants (drivers or riders, or both). In this case, the buffer size can be set manually or calculated automatically.

All drivers and buffered requests are matched together according to the each-to-each principle. Then, the system finds optimal matches using filters (starting with the least computationally intensive):

(A) Based on empirical factors. For example, wrong car class; the driver having rejected similar ride requests; or the rider having blacklisted the driver.

(B) Based on a formula that ranks matches among a set of matches, and an algorithm that finds the currently most optimal match among the ranked matches. For each match, a similarity score is calculated based on the factors listed above. This score can be calculated: (i) based on an empirical formula (e.g., based on practical experience, such as a linear formula (0.7)*distance to passenger +(−0.3)*driver rating); or (ii) based on a formula with historical data calculated using a machine learning model, such as supervised learning; or (iii) based on a formula with historical data calculated using a deep-learning model, such as reinforcement learning. The algorithm ranks matches according to their similarity and selects matches with the highest score on the part of the driver and/or rider. The algorithm may adapt to the state of supply and demand. For example, if there is lack of demand, the algorithm shifts priorities in choosing the optimal match in the driver's favour. Thus, ride requests, which are “bad” from the driver's point of view (e.g., ones that have long routes or low prices), are not matched.

An optimal driver-request match is a match, in which the driver is most likely to respond and fulfill the ride, while the rider is most likely to accept this driver for the ride. Drivers and riders are suggested not one match, but a number of matches, which are ranked according to the probability of making the ride. Thus, the proposed system satisfies both the drivers' and riders' needs. After the ride is completed, the system receives a feedback on which match has been chosen for the ride. This feedback allows to refine the parameters of the system in order to better determine probabilities in the future.

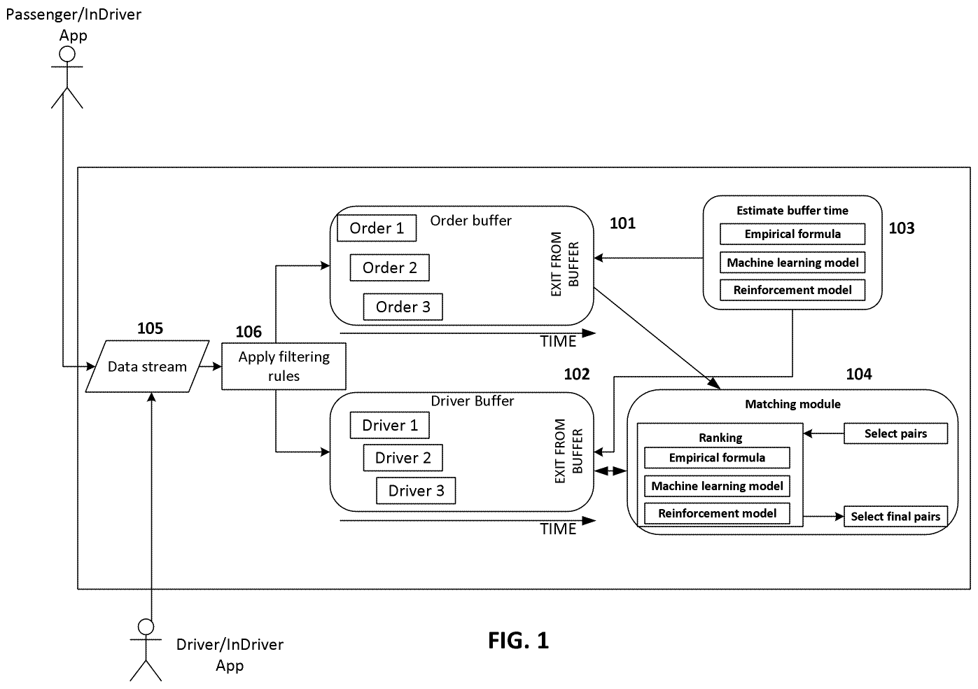

FIG. 1 shows components of the system. As shown in FIG. 1, both drivers and passengers connect to the system using an application on their smartphones. The data is combined into a datastream 105, and filtered in a filtering module 106. Two buffers can be used—an order buffer 101 to manage orders from the passengers, and a driver's buffer 102, to manage the available drivers.

A matching module 104 uses a ranking algorithm that can utilize an empirical formula (like what?), a machine learning model or a reinforcement model to match drivers and passengers. Once the driver and the passenger are matched, the corresponding orders are removed from the buffers. Element 103 uses similar instruments as 104, but for a different task. Element 103 estimates the buffer time, while element 104 selects the pairs to send the notifications to.

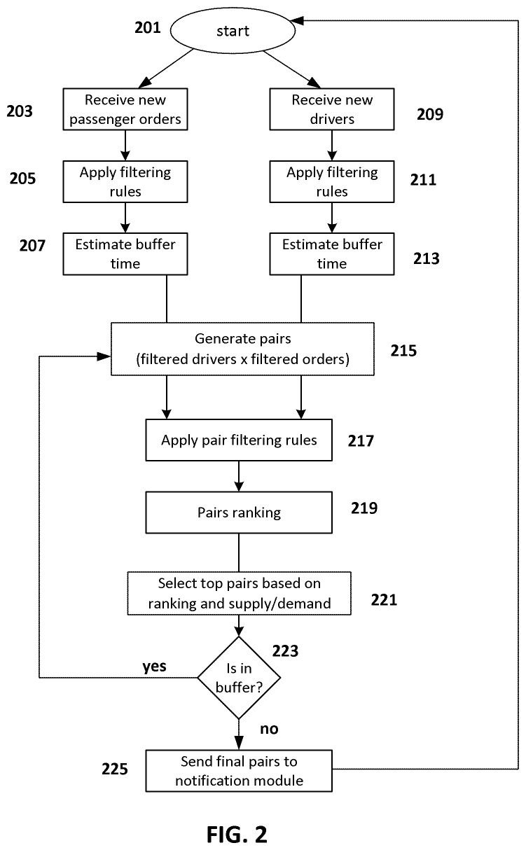

FIG. 2 shows an algorithm that may be used in the present invention. Once the system starts in step 201, it receives new passenger orders (step 203) and new availability information about the drivers (step 209). It then applies filtering rules to them in steps 205 and 211. Buffer time is estimated in steps 207 and 213. In step 215, filtered driver-filtered passenger pairs are matched. Pair filtering rules are applied in step 217. A ranking is performed in step 219. In step 221, top pairs are selected based on ranking and supply/demand. If the order or the driver is not in the buffer (step 223), for example, because the pair is pushed out of the buffer, e.g., due to time constraints, for example, some maximum time (e.g., 20 seconds) defined by the system administrator, the final pair is sent to the notification module, to inform the driver and their passenger of their match. The process then returns to the start step 201, and continues cycling. If the order is still in the buffer, then the algorithm returns to step 215.

The number of drivers in the bidding is controlled based on the size of demand. The size of demand can be calculated as a ratio between the number of ride requests and the number of drivers. By regulating the number of drivers in the bidding (e.g., reducing the number of notifications to the drivers), in the case of high/low demand, it is possible to “match” more participants of the bidding.

The system can be set up to preference or de-preference (which is more common) those users who is prone to reject or ignore notifications (for example, work as the taxi driver on irregular basis, or passengers who have a history of invoking their application and putting in an order).

In the proposed system all available drivers will be considered and perform the entire calculation pipeline for everybody will be performed. But the notifications will be send to ones who are more likely to accept it due to personal preferences. Thus, the system will see fewer notifications and thus optimize the load only for the sending server but not for the whole system.

Note that the application for the driver can have an online/offline toggle. The driver can switch it manually. This toggle should also automatically turn off if the driver has not been active in the last 15 minutes (or some other pre-defined amount of time) or ignored several notification in a row. Only drivers who have the toggle switch in the “online” state are notified about a possible passenger, thereby filtering out drivers who at the moment are not interested in taking an order.

Additionally, as an option, the system can prioritize those drivers who are most interested in the service (especially given that many drivers might be signed up with other p2p services), and de-prioritize those who are less interested. Also, active/inactive status may be indicated by driver behavior, as he is driving around and participating (or not participating) in bid-counteroffer negotiations, rather than by his pre-set preferences. Presumably, such drivers are of more value to the overall system, since they are the most interested and, therefore, most active—unlike other drivers, who might be there, in the city sector, geographically, and even logged in and nominally participating in the process, but not doing much.

Thus, unlike many conventional solutions, a buffer for both riders and drivers is used. It is also possible to choose freely or reject the offered driver-rider match; one does not have to accept the proposed ride request/driver. It is possible for the rider/driver to set their price. It is also possible for driver and passenger to engage in price negotiations.

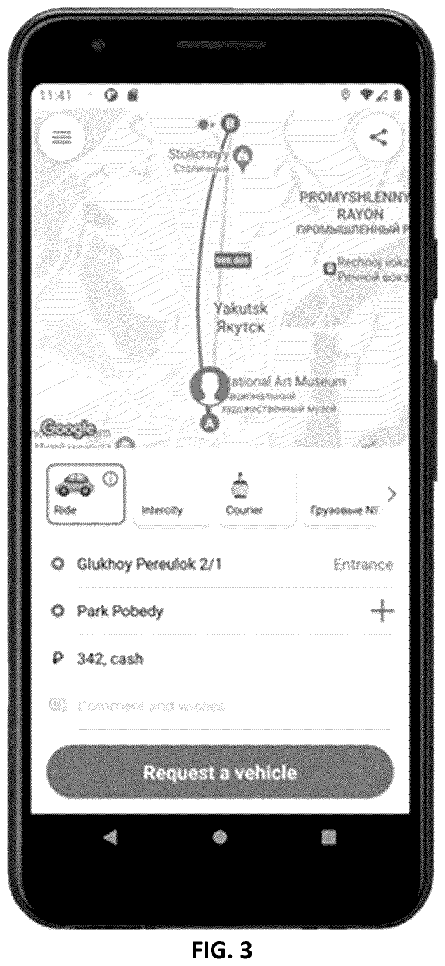

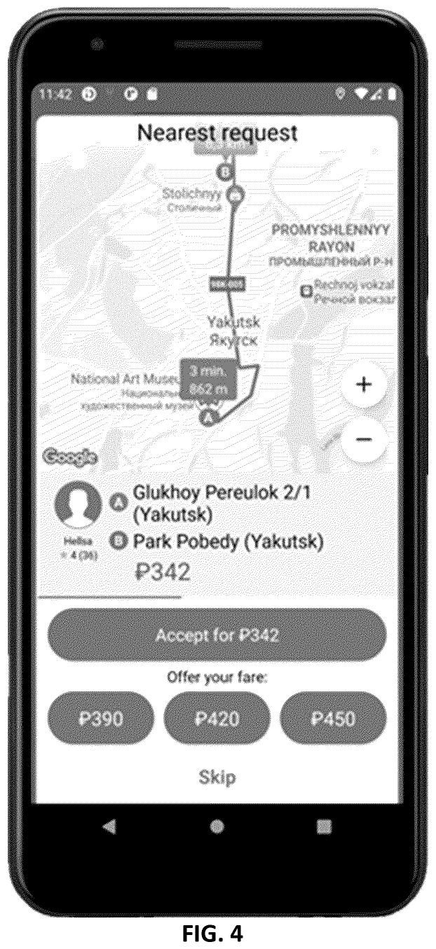

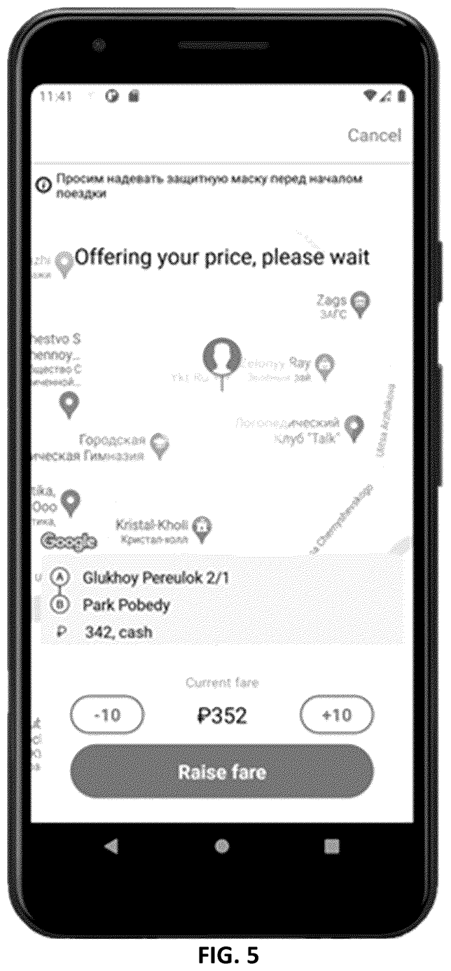

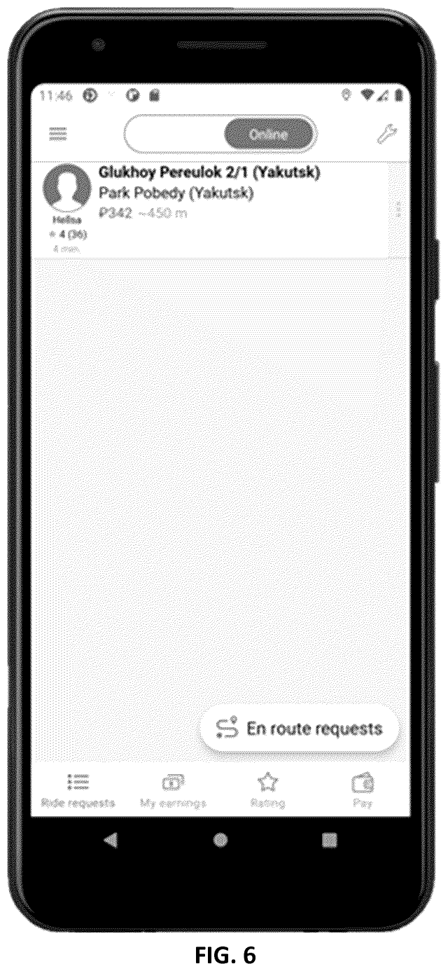

FIG. 3 shows a passenger's smartphone screen for creating an order, with an offering price (here, in rubles). FIG. 4 shows a driver's screen, notifying him of the incoming order. The driver has an option to accept the offered price, to raise the price as a counteroffer, or to refuse the order. FIG. 5 shows a passenger's screen, as he waits for the driver to either accept the order or to counter with a higher price. It should be noted that the rider can raise the fare (for example in case of no driver accepting the current deal). FIG. 6 shows a driver's screen, with the active/inactive option at the top.

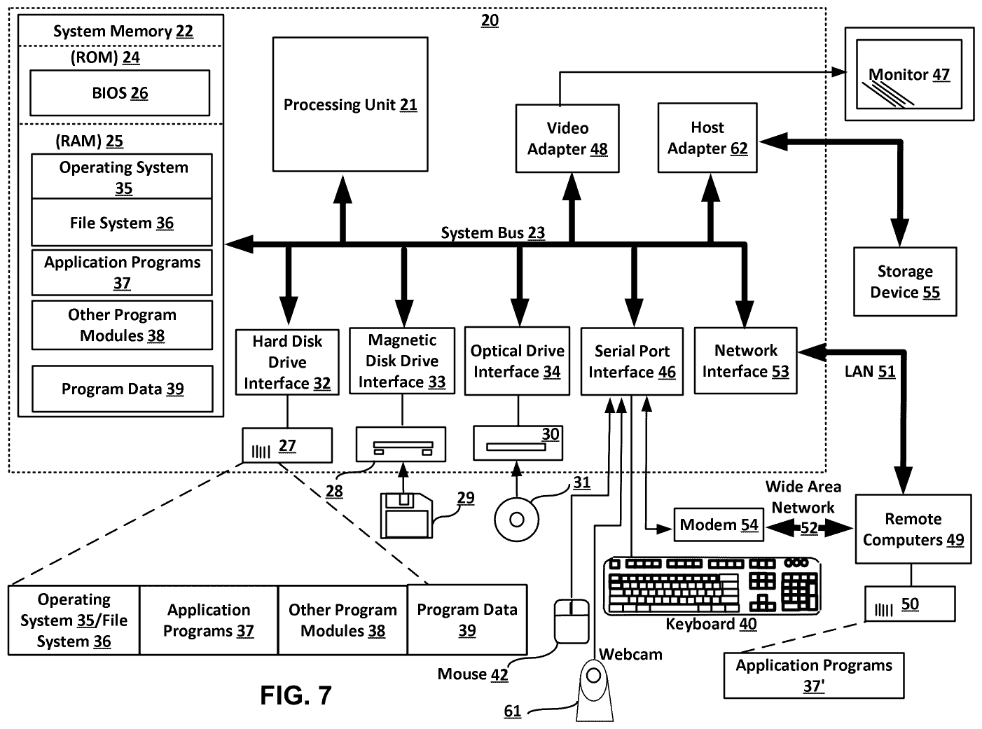

With reference to FIG. 7, an exemplary system for implementing the invention includes a general purpose computing device in the form of a host computer or a server 20 or the like, including a processing unit (CPU) 21, a system memory 22, and a system bus 23 that couples various system components including the system memory to the processing unit 21.

The system bus 23 may be any of several types of bus structures including a memory bus or memory controller, a peripheral bus, and a local bus using any of a variety of bus architectures. The system memory includes a read-only memory (ROM) 24 and random access memory (RAM) 25. A basic input/output system 26 (BIOS), containing the basic routines that help to transfer information between the elements within the computer 20, such as during start-up, is stored in ROM 24.

The computer or server 20 may further include a hard disk drive 27 for reading from and writing to a hard disk, not shown herein, a magnetic disk drive 28 for reading from or writing to a removable magnetic disk 29, and an optical disk drive 30 for reading from or writing to a removable optical disk 31 such as a CD-ROM, DVD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively.

The drives and their associated computer-readable media provide non-volatile storage of computer readable instructions, data structures, program modules and other data for the server 20. Although the exemplary environment described herein employs a hard disk (storage device 55), a removable magnetic disk 29 and a removable optical disk 31, it should be appreciated by those skilled in the art that other types of computer readable media that can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk (storage device 55), magnetic disk 29, optical disk 31, ROM 24 or RAM 25, including an operating system 35 (e.g., MICROSOFT WINDOWS, LINUX, APPLE OS X or similar). The server/computer 20 includes a file system 36 associated with or included within the operating system 35, such as the Windows NT™ File System (NTFS) or similar, one or more application programs 37, other program modules 38 and program data 39. A user may enter commands and information into the server 20 through input devices such as a keyboard 40, a webcam 61 and pointing device (e.g., a mouse) 42.

Other input devices (not shown) may include a microphone, joystick, game pad, scanner or the like. These and other input devices are often connected to the processing unit 21 through a serial port interface 46 that is coupled to the system bus, and they may also be connected by other interfaces, such as a parallel port, game port or universal serial bus (USB). A monitor 47 or other type of display device is also connected to the system bus 23 via an interface, such as a video adapter 48. In addition to the monitor 47, computers typically include other peripheral output devices (not shown), such as speakers and printers. A host adapter 62 is used to connect to the storage device 55.

The server/computer 20 may operate in a networked environment using logical connections to one or more remote computers 49. The remote computer (or computers) 49 may be another personal computer, a server, a router, a network PC, a peer device or other common network node, and it typically includes some or all of the elements described above relative to the server 20, although here only a memory storage device 50 with application software 37′ is illustrated. The logical connections include a local area network (LAN) 51 and a wide area network (WAN) 52. Such networking environments are common in offices, enterprise-wide computer networks, Intranets and the Internet.

In a LAN environment, the server/computer 20 is connected to the local network 51 through a network interface or adapter 53. When used in a WAN networking environment, the server 20 typically includes a modem 54 or other means for establishing communications over the wide area network 52, such as the Internet.

The modem 54, which may be internal or external, is connected to the system bus 23 via the serial port interface 46. In a networked environment, the program modules depicted relative to the computer or server 20, or portions thereof, may be stored in the remote memory storage device. It will be appreciated that the network connections shown are merely exemplary and other means of establishing a communications link between the computers may be used.

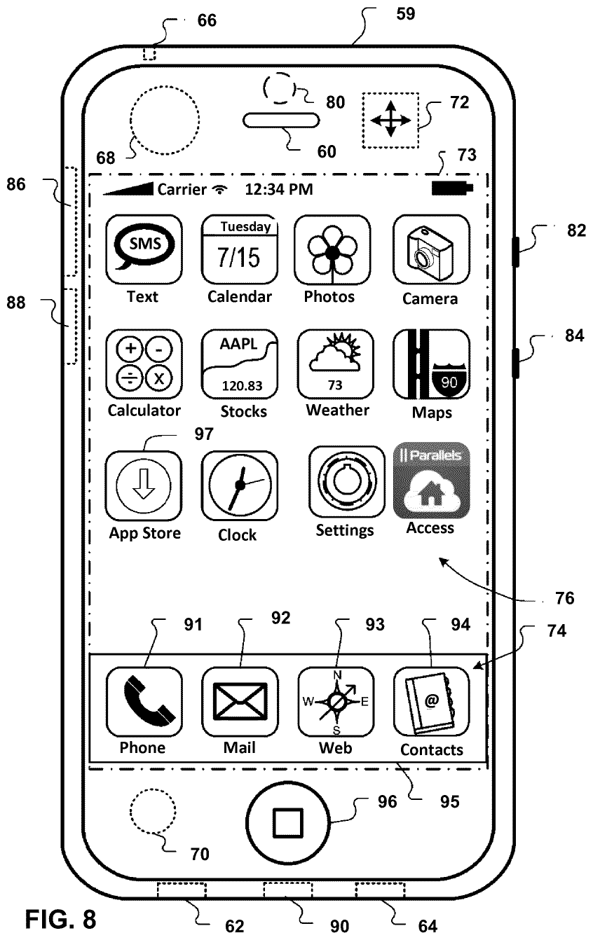

FIG. 8 is a block diagram of an exemplary mobile device 59 on which the invention can be implemented. The mobile device 59 can be, for example, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, the mobile device 59 includes a touch-sensitive display 73. The touch-sensitive display 73 can implement liquid crystal display (LCD) technology, light emitting polymer display (LPD) technology, or some other display technology. The touch-sensitive display 73 can be sensitive to haptic and/or tactile contact with a user.

In some implementations, the touch-sensitive display 73 can comprise a multi-touch-sensitive display 73. A multi-touch-sensitive display 73 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device.

In some implementations, the mobile device 59 can display one or more graphical user interfaces on the touch-sensitive display 73 for providing the user access to various system objects and for conveying information to the user. In some implementations, the graphical user interface can include one or more display objects 74, 76. In the example shown, the display objects 74, 76, are graphic representations of system objects. Some examples of system objects include device functions, applications, windows, files, alerts, events, or other identifiable system objects.

In some implementations, the mobile device 59 can implement multiple device functionalities, such as a telephony device, as indicated by a phone object 91; an e-mail device, as indicated by the e-mail object 92; a network data communication device, as indicated by the Web object 93; a Wi-Fi base station device (not shown); and a media processing device, as indicated by the media player object 94. In some implementations, particular display objects 74, e.g., the phone object 91, the e-mail object 92, the Web object 93, and the media player object 94, can be displayed in a menu bar 95. In some implementations, device functionalities can be accessed from a top-level graphical user interface, such as the graphical user interface illustrated in the figure. Touching one of the objects 91, 92, 93 or 94 can, for example, invoke corresponding functionality.

In some implementations, the mobile device 59 can implement network distribution functionality. For example, the functionality can enable the user to take the mobile device 59 and its associated network while traveling. In particular, the mobile device 59 can extend Internet access (e.g., Wi-Fi) to other wireless devices in the vicinity. For example, mobile device 59 can be configured as a base station for one or more devices. As such, mobile device 59 can grant or deny network access to other wireless devices.

In some implementations, upon invocation of device functionality, the graphical user interface of the mobile device 59 changes, or is augmented or replaced with another user interface or user interface elements, to facilitate user access to particular functions associated with the corresponding device functionality. For example, in response to a user touching the phone object 91, the graphical user interface of the touch-sensitive display 73 may present display objects related to various phone functions; likewise, touching of the email object 92 may cause the graphical user interface to present display objects related to various e-mail functions; touching the Web object 93 may cause the graphical user interface to present display objects related to various Web-surfing functions; and touching the media player object 94 may cause the graphical user interface to present display objects related to various media processing functions.

In some implementations, the top-level graphical user interface environment or state can be restored by pressing a button 96 located near the bottom of the mobile device 59. In some implementations, each corresponding device functionality may have corresponding “home” display objects displayed on the touch-sensitive display 73, and the graphical user interface environment can be restored by pressing the “home” display object.

In some implementations, the top-level graphical user interface can include additional display objects 76, such as a short messaging service (SMS) object, a calendar object, a photos object, a camera object, a calculator object, a stocks object, a weather object, a maps object, a notes object, a clock object, an address book object, a settings object, and an app store object 97. Touching the SMS display object can, for example, invoke an SMS messaging environment and supporting functionality; likewise, each selection of a display object can invoke a corresponding object environment and functionality.

Additional and/or different display objects can also be displayed in the graphical user interface. For example, if the device 59 is functioning as a base station for other devices, one or more “connection” objects may appear in the graphical user interface to indicate the connection. In some implementations, the display objects 76 can be configured by a user, e.g., a user may specify which display objects 76 are displayed, and/or may download additional applications or other software that provides other functionalities and corresponding display objects.

In some implementations, the mobile device 59 can include one or more input/output (I/O) devices and/or sensor devices. For example, a speaker 60 and a microphone 62 can be included to facilitate voice-enabled functionalities, such as phone and voice mail functions. In some implementations, an up/down button 84 for volume control of the speaker 60 and the microphone 62 can be included. The mobile device 59 can also include an on/off button 82 for a ring indicator of incoming phone calls. In some implementations, a loud speaker 64 can be included to facilitate hands-free voice functionalities, such as speaker phone functions. An audio jack 66 can also be included for use of headphones and/or a microphone.

In some implementations, a proximity sensor 68 can be included to facilitate the detection of the user positioning the mobile device 59 proximate to the user's ear and, in response, to disengage the touch-sensitive display 73 to prevent accidental function invocations. In some implementations, the touch-sensitive display 73 can be turned off to conserve additional power when the mobile device 59 is proximate to the user's ear.

Other sensors can also be used. For example, in some implementations, an ambient light sensor 70 can be utilized to facilitate adjusting the brightness of the touch-sensitive display 73. In some implementations, an accelerometer 72 can be utilized to detect movement of the mobile device 59, as indicated by the directional arrows. Accordingly, display objects and/or media can be presented according to a detected orientation, e.g., portrait or landscape. In some implementations, the mobile device 59 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 59 or provided as a separate device that can be coupled to the mobile device 59 through an interface (e.g., port device 90) to provide access to location-based services.

The mobile device 59 can also include a camera lens and sensor 80. In some implementations, the camera lens and sensor 80 can be located on the back surface of the mobile device 59. The camera can capture still images and/or video.

The mobile device 59 can also include one or more wireless communication subsystems, such as an 802.11b/g communication device 86, and/or a BLUETOOTH communication device 88. Other communication protocols can also be supported, including other 802.x communication protocols (e.g., WiMax, Wi-Fi, 3G, LTE), code division multiple access (CDMA), global system for mobile communications (GSM), Enhanced Data GSM Environment (EDGE), etc.

In some implementations, the port device 90, e.g., a Universal Serial Bus (USB) port, or a docking port, or some other wired port connection, is included. The port device 90 can, for example, be utilized to establish a wired connection to other computing devices, such as other communication devices 59, network access devices, a personal computer, a printer, or other processing devices capable of receiving and/or transmitting data. In some implementations, the port device 90 allows the mobile device 59 to synchronize with a host device using one or more protocols, such as, for example, the TCP/IP, HTTP, UDP and any other known protocol. In some implementations, a TCP/IP over USB protocol can be used.

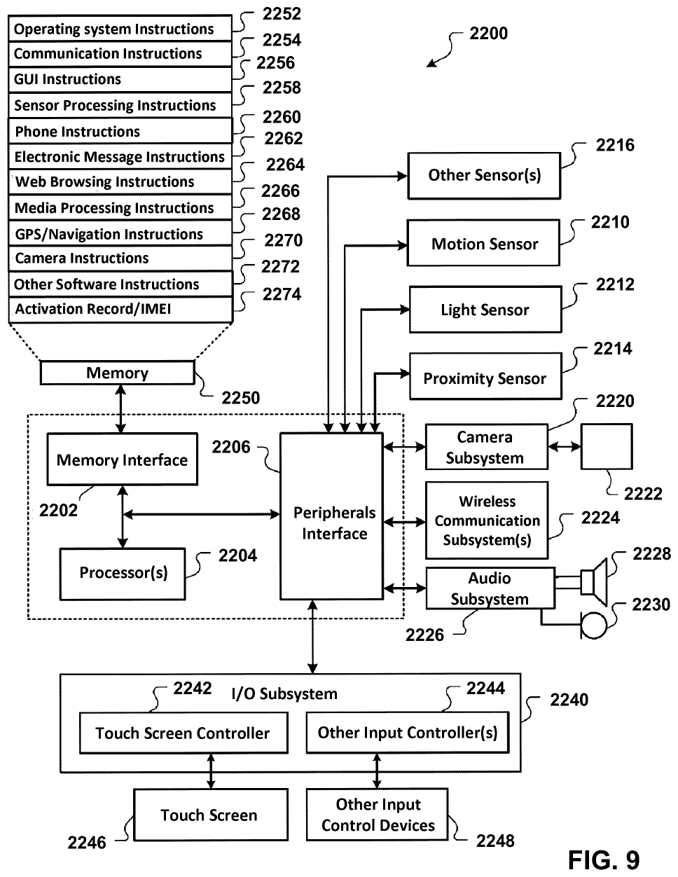

FIG. 9 is a block diagram 2200 of an example implementation of the mobile device 59. The mobile device 59 can include a memory interface 2202, one or more data processors, image processors and/or central processing units 2204, and a peripherals interface 2206. The memory interface 2202, the one or more processors 2204 and/or the peripherals interface 2206 can be separate components or can be integrated in one or more integrated circuits. The various components in the mobile device 59 can be coupled by one or more communication buses or signal lines.

Sensors, devices and subsystems can be coupled to the peripherals interface 2206 to facilitate multiple functionalities. For example, a motion sensor 2210, a light sensor 2212, and a proximity sensor 2214 can be coupled to the peripherals interface 2206 to facilitate the orientation, lighting and proximity functions described above. Other sensors 2216 can also be connected to the peripherals interface 2206, such as a positioning system (e.g., GPS receiver), a temperature sensor, a biometric sensor, or other sensing device, to facilitate related functionalities.

A camera subsystem 2220 and an optical sensor 2222, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 2224, which can include radio frequency receivers and transmitters and/or optical (e.g., infrared) receivers and transmitters. The specific design and implementation of the communication subsystem 2224 can depend on the communication network(s) over which the mobile device 59 is intended to operate. For example, a mobile device 59 may include communication subsystems 2224 designed to operate over a GSM network, a GPRS network, an EDGE network, a Wi-Fi or WiMax network, and a BLUETOOTH network. In particular, the wireless communication subsystems 2224 may include hosting protocols such that the device 59 may be configured as a base station for other wireless devices.

An audio subsystem 2226 can be coupled to a speaker 2228 and a microphone 2230 to facilitate voice-enabled functions, such as voice recognition, voice replication, digital recording, and telephony functions.

The I/O subsystem 2240 can include a touch screen controller 2242 and/or other input controller(s) 2244. The touch-screen controller 2242 can be coupled to a touch screen 2246. The touch screen 2246 and touch screen controller 2242 can, for example, detect contact and movement or break thereof using any of multiple touch sensitivity technologies, including but not limited to capacitive, resistive, infrared, and surface acoustic wave technologies, as well as other proximity sensor arrays or other elements for determining one or more points of contact with the touch screen 2246.

The other input controller(s) 2244 can be coupled to other input/control devices 2248, such as one or more buttons, rocker switches, thumb-wheel, infrared port, USB port, and/or a pointer device such as a stylus. The one or more buttons (not shown) can include an up/down button for volume control of the speaker 2228 and/or the microphone 2230.

In one implementation, a pressing of the button for a first duration may disengage a lock of the touch screen 2246; and a pressing of the button for a second duration that is longer than the first duration may turn power to the mobile device 59 on or off. The user may be able to customize a functionality of one or more of the buttons. The touch screen 2246 can, for example, also be used to implement virtual or soft buttons and/or a keyboard.

In some implementations, the mobile device 59 can present recorded audio and/or video files, such as MP3, AAC, and MPEG files. In some implementations, the mobile device 59 can include the functionality of an MP3 player. The mobile device 59 may, therefore, include a 32-pin connector that is compatible with the MP3 player. Other input/output and control devices can also be used.

The memory interface 2202 can be coupled to memory 2250. The memory 2250 can include high-speed random access memory and/or non-volatile memory, such as one or more magnetic disk storage devices, one or more optical storage devices, and/or flash memory (e.g., NAND, NOR). The memory 2250 can store an operating system 2252, such as Darwin, RTXC, LINUX, UNIX, OS X, ANDROID, IOS, WINDOWS, or an embedded operating system such as VxWorks. The operating system 2252 may include instructions for handling basic system services and for performing hardware dependent tasks. In some implementations, the operating system 2252 can be a kernel (e.g., UNIX kernel).

The memory 2250 may also store communication instructions 2254 to facilitate communicating with one or more additional devices, one or more computers and/or one or more servers. The memory 2250 may include graphical user interface instructions 2256 to facilitate graphic user interface processing including presentation, navigation, and selection within an application store; sensor processing instructions 2258 to facilitate sensor-related processing and functions; phone instructions 2260 to facilitate phone-related processes and functions; electronic messaging instructions 2262 to facilitate electronic-messaging related processes and functions; web browsing instructions 2264 to facilitate web browsing-related processes and functions; media processing instructions 2266 to facilitate media processing-related processes and functions; GPS/Navigation instructions 2268 to facilitate GPS and navigation-related processes and instructions; camera instructions 2270 to facilitate camera-related processes and functions; and/or other software instructions 2272 to facilitate other processes and functions.

Each of the above identified instructions and applications can correspond to a set of instructions for performing one or more functions described above. These instructions need not be implemented as separate software programs, procedures or modules. The memory 2250 can include additional instructions or fewer instructions. Furthermore, various functions of the mobile device 59 may be implemented in hardware and/or in software, including in one or more signal processing and/or application specific integrated circuits.

Having thus described a preferred embodiment, it should be apparent to those skilled in the art that certain advantages of the described method and apparatus have been achieved. It should also be appreciated that various modifications, adaptations, and alternative embodiments thereof may be made within the scope and spirit of the present invention.

What is claimed is:

1. A system for optimizing matching drivers and passengers in a p2p ride service, comprising:
a mobile phone with an application that connects to a server, that passengers can use to place an order for a ride;
the application including an option to function as a driver application that a driver can use to accept the order placed by the passenger;
the server receiving the orders from multiple passengers;
the server filtering the orders to ensure that the order is valid given a set of pre-defined parameters;
the server placing the orders into a buffer and determining an optimal time for each order to remain in the buffer, based on historical data for the passenger and current traffic and driver availability data;
the server generating a set of active drivers;
the server generating a set of possible matched pairs of passengers and drivers, where every possible passenger with an outstanding order is paired to every possible active driver;
the server filtering the possible matched pairs to determine those matched pairs that satisfy both the passenger's criteria and the driver's criteria;
for each filtered matched pair, the server calculating a probability of the ride taking place;
the server ranking the filtered matched pairs based on the probability;
the server selecting optimal matched pairs, out of the filtered matched pairs, for each passenger and each driver, such that each driver only has one possible passenger, but each passenger can have multiple possible drivers;
for orders that are pushed out of the buffer after a pre-defined time, the server sending notifications to the corresponding drivers from the selected optimal matched pairs;
for those orders that are accepted by the drivers with their counteroffers, the corresponding passengers are notified by the server, and the passenger is given an option to either accept this driver and his counteroffer or decline this driver.

2. A system for optimizing matching drivers and passengers in a p2p ride service, comprising:
a server in communication with a mobile phone application that is used by passengers for placing orders for rides;
the server configured to
(i) receive the orders from multiple passengers;
(ii) filter the orders to ensure that the order is valid;
(iii) place the orders into a buffer and determining an optimal time for each order to remain in the buffer, based on historical data for the passenger who placed that order and current traffic and driver availability data;
(iv) generate a set of active drivers;
(v) generate a set of possible matched pairs of passengers and drivers, where every possible passenger with an outstanding order is paired to every possible active driver;
(vi) filter the possible matched pairs to determine those matched pairs that satisfy both the passenger's criteria and the driver's criteria;
(vii) for each filtered matched pair, calculate a probability of the ride taking place;
(viii) rank the filtered matched pairs based on the probability;
(ix) select optimal matched pairs, out of the filtered matched pairs, for each passenger and each driver, such that each driver only has one possible passenger, but each passenger can have multiple possible drivers;
(x) for orders that are pushed out of the buffer after a pre-defined time, send notifications to the corresponding drivers from the selected optimal matched pairs;
(xi) for those orders that are accepted by the drivers with their counteroffers, notifying the corresponding passengers, and giving the passengers an option to either accept this driver and his counteroffer or decline this driver.

3. The system of claim 2, wherein the application includes functionality for a driver application that a driver can use to accept the order placed by the passenger;

4. A method for optimizing matching drivers and passengers in a p2p ride service on a server, the method comprising
(i) receiving the orders from multiple passengers;
(ii) filtering the orders to ensure that the order is valid;
(iii) placing the orders into a buffer and determining an optimal time for each order to remain in the buffer, based on historical data for the passenger who placed that order and current traffic and driver availability data;
(iv) generating a set of active drivers;
(v) generating a set of possible matched pairs of passengers and drivers, where every possible passenger with an outstanding order is paired to every possible active driver;
(vi) filtering the possible matched pairs to determine those matched pairs that satisfy both the passenger's criteria and the driver's criteria;
(vii) for each filtered matched pair, calculating a probability of the ride taking place;
(viii) ranking the filtered matched pairs based on the probability;
(ix) selecting optimal matched pairs, out of the filtered matched pairs, for each passenger and each driver, such that each driver only has one possible passenger, but each passenger can have multiple possible drivers;
(x) for orders that are pushed out of the buffer after a pre-defined time, sending notifications to the corresponding drivers from the selected optimal matched pairs;
(xi) for those orders that are accepted by the drivers with their counteroffers, notifying the corresponding passengers, and giving the passengers an option to either accept this driver and his counteroffer or decline this driver.
